(19) United States
(12) Patent Application Publication
(10) Pub. No.: US 2014/0178559 A1
(43) Pub. Date: Jun. 26, 2014

(54) Cold-Brewed Instant Coffee

(71) Applicant: Robert Neace, JR., Vancouver, WA (US)

(72) Inventor: Robert Neace, JR., Vancouver, WA (US)

(73) Assignee: Bean Logic LLC, Vancouver, WA (US)

(21) Appl. No.: 14/235,343

(22) PCT Filed: Jul. 27, 2012
(86) PCT No.: PCT/US2012/048705

§ 371 Date: Jan. 27, 2014

Related U.S. Application Data
(60) Provisional application No. 61/513,436, filed on Jul. 29, 2011.

(51) Int. Cl. A23F 5/36; A23F 5/26

(52) U.S. Cl. CPC A23F 5/36; A23F 5/26
USPC 426/594; 426/432

(57) ABSTRACT

Embodiments of the invention are directed to instant coffee and methods of preparing the same, wherein the methods include adding water having a temperature of less than 117° F. to ground coffee beans to result in a slurry with liquid and solid components, maintaining the slurry at a temperature below 117° F. for at least one hour, separating the liquid component of the slurry from the solid component, to yield a liquid coffee extract, and subjecting the liquid coffee extract to a drying process to remove water from the liquid coffee extract, to yield a solid coffee extract which can be used as an instant coffee. Embodiments of the invention are also directed to blended instant coffees and methods of preparing the same.

### CROSS REFERENCE TO RELATED APPLICATION

The present application claims the benefit of priority under 35 U.S.C. §119(e) to U.S. Provisional Application No. 61/513,436, COFFEE CONCENTRATE, filed on Jul. 29, 2011, which is currently co-pending herewith and which is incorporated by reference in its entirety.

### FIELD OF THE INVENTION

The invention disclosed herein generally relates to a process for creating a cold-brewed instant coffee.

### BACKGROUND

Instant coffee, also known as soluble coffee and coffee powder, is a beverage prepared by rehydrating dried brewed coffee beans to yield a liquid instant coffee product. Instant coffee was invented in 1901 by Satori Kato, a Japanese scientist working in Chicago, and the Nescafe® brand of instant coffee products was launched in 1938 around an advanced coffee refining process. High-vacuum freeze-dried coffee was developed shortly after World War II.

The advantages of powdered instant coffee include speed of preparation, lower shipping weight and volume as compared to whole coffee beans or ground coffee, and longer shelf life. However, despite these advantages, instant coffee has heretofore not been widely adopted by coffee drinkers, as many consumers find the flavor of instant coffee to be stale and/or bitter. In addition, most current instant coffee products spoil if not kept dry, such that the quality of the product and the consumer experience are degraded once the instant coffee packaging seal is broken.

### SUMMARY OF THE INVENTION

Embodiments of the invention encompass methods of producing an instant coffee, the method including: adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee. In some embodiments of the methods the coffee beans have been roasted.

In some embodiments, the slurry can be prepared with water having a temperature of less than 106° F. In some embodiments, the slurry can be prepared with water having a temperature of less than 90° F. In some embodiments, the slurry can be prepared with water having a temperature of less than 70° F. In some embodiments, the slurry can be prepared with water having a temperature of less than 50° F.

In some embodiments, the slurry can be maintained at a temperature below 106° F. In some embodiments, the slurry can be maintained at a temperature below 90° F. In some embodiments, the slurry can be maintained at a temperature below 70° F. In some embodiments, the slurry can be maintained at a temperature below 50° F.

In some embodiments, the slurry can be maintained for 2 hours or more. In some embodiments, the slurry can be maintained for 6 hours or more. In some embodiments, the slurry can be maintained for 12 hours or more. In some embodiments, the slurry can be maintained for 18 hours or more. In some embodiments, the slurry can be maintained for 24 hours or more. In some embodiments, the slurry can be maintained for 48 hours or more. In some embodiments, the slurry can be maintained for 60 hours or more.

In some embodiments, the slurry cannot be allowed to be agitated. In some embodiments, the slurry can be subject to agitation.

In some embodiments, separation of the liquid component of the slurry from the solid component includes one or more of filtering, decanting, pressing, centrifuging, pressurizing and extracting with air, or pressurizing and extracting with steam.

In some embodiments, the drying process includes one or more of freeze drying, spray drying, centrifugation, vacuum drying, use of radiant heat, drying at ambient temperature, application of infrared heat, evaporation, drum drying, dehydration, shelf drying, and solar drying.

In some embodiments, the drying process results in a coffee extract with a water content of less than 25%. In some embodiments, the drying process results in a coffee extract with a water content of less than 5%. In some embodiments, the drying process results in a coffee extract with a water content of less than 1%.

In some embodiments, the temperature during the drying process can be above 117° F. In some embodiments, the temperature during the drying process can be above 117° F. for less than the entirety of the drying process. In some embodiments, the temperature during the drying process can be at or below 160° F. In some embodiments, the temperature during the drying process can be at or below 117° F. In some embodiments, the temperature during the drying process can be at or below 106° F. In some embodiments, the temperature during the drying process can be at or below 90° F. In some embodiments, the temperature during the drying process can be at or below 70° F. In some embodiments, the temperature during the drying process can be at or below 50° F.

Embodiments of the invention also include instant coffees prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee.

Embodiments of the invention also include methods of preparing coffee beverages, including adding water to the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee.

Embodiments of the invention also include coffee beverages prepared by adding water to the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee.

In some embodiments, the coffee beverage prepared by adding water to the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can be a low acid coffee. In some embodiments, the coffee beverage prepared by adding water to the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can be a low cafestol coffee. In some embodiments, the coffee beverage prepared by adding water to the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can be a low kahweol coffee.

Embodiments of the invention also relate to methods of preparing a blended instant coffee, including adding water to a mixture of the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, and one or more other instant coffee. In some embodiments, the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 5% of the mixture. In some embodiments, the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 25% of the mixture. In some embodiments, the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 50% of the mixture.

Embodiments of the invention also relate to coffee beverages prepared by adding water to a mixture of the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, and one or more other instant coffee.

Embodiments of the invention also include methods of preparing a blended instant coffee, including adding water to a mixture of the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, and cacao or cocoa. In some embodiments, the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 5% of the mixture. In some embodiments, the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 25% of the mixture. In some embodiments, the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 50% of the mixture.

Embodiments of the invention also include coffee beverages prepared by adding water to a mixture of the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, and cacao or cocoa.

Embodiments of the invention also relate to methods of preparing a blended instant coffee, including adding water to a mixture of the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, cacao or cocoa, and one or more other instant coffee. In some embodiments, the instant coffee of prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 5% of the mixture. In some embodiments, the instant coffee of prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 25% of the mixture. In some embodiments, the instant coffee of prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, can represent at least 50% of the mixture.

Embodiments of the invention also relate to coffee beverages prepared by adding water to a mixture of the instant coffee prepared by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee, cacao or cocoa, and one or more other instant coffee.

Embodiments of the invention also encompass methods for preparing a coffee beverage, the methods including: preparing an instant coffee by adding water having a temperature of less than 117° F. to ground coffee beans to result in a slurry with liquid and solid components; maintaining the slurry at a temperature below 117° F. for at least one hour; separating the liquid component of the slurry from the solid component, to yield a liquid coffee extract; and subjecting the liquid coffee extract to a drying process to remove water from the liquid coffee extract, to yield a solid coffee extract which can be used as an instant coffee; packaging the instant coffee under conditions that preserve the moisture content at less than about 5% by weight; delivering the packaged instant coffee to a location of a coffee consumer; and combining a portion of the packaged instant coffee with water to yield a coffee beverage.

### DETAILED DESCRIPTION OF THE INVENTION

All references cited herein are incorporated by reference in their entirety.

Unless otherwise noted, terms are to be understood according to conventional usage by those of ordinary skill in the relevant art. Where a definition or use of a term in a reference, which is incorporated by reference herein, is inconsistent or contrary to the definition of that term provided herein, the definition of that term provided herein applies, and the definition of that term in the reference does not apply.

As used herein, the term “instant coffee” refers to a coffee extract in solid form. The solid can be, for example, powdered, granular, crystalline, or the like. The solid can be uniform or non-uniform.

As used herein, the terms “liquid coffee concentrate” and “liquid coffee extract” refer to a coffee extract in liquid form. The liquid can be of any viscosity or concentration. The liquid can also contain some percentage of water.

Instant coffee is commercially prepared by either freeze-drying or spray drying an extract of coffee beans, which can have been pre-treated by roasting, after which the dried extract can be rehydrated by the consumer. Pre-treatment via roasting has an effect on the flavor of the coffee produced from the coffee beans, which many consumers consider to be a desirable effect. A form of instant coffee has also been produced in concentrated liquid form.

Instant coffee products have experienced limited acceptance from coffee consumers, primarily due to the frequent stale, bitter, or “off” flavors associated with instant coffee. Accordingly, dating from initial development of instant coffee, efforts have been undertaken to produce powdered coffee concentrates with improved flavor characteristics, expressing full coffee flavor with minimal to no stale, bitter, or “off” flavors.

In recent years, various approaches have been utilized to produce a more flavorful coffee concentrate that can be used to yield an improved “instant” coffee beverage. For example, U.S. Pat. No. 6,602,538, COFFEE CONCENTRATE, issued to Watkins, Jr., et al., provides a liquid coffee concentrate that is shelf-stable for extended periods at ambient temperatures. The liquid coffee concentrate is obtained through a cold extraction process and processed to a dry powder under ultra-high temperature conditions, at boiling or even higher under pressure, and then aseptically packaged to preserve flavor as a ready-to-pour coffee beverage.

In another example, United States Patent Application No. 20080148955, APPARATUS FOR EXTRACTING COLD-BREWED COFFEE CONCENTRATE, to Neace, et al., provides an apparatus for extracting a coffee in the form of a liquid extract through cold water infusion, which results in a more flavorful coffee product than a conventionally hot-brewed coffee. The apparatus and brewing process result in a concentrated coffee beverage that is ready to drink.

In another example, United States Patent Application No. 20070224330, COFFEE EXTRACTING METHOD AND COFFEE ICE CUBE WITH PREVENTING FLAVOR LOSING, to Cheng, provides a method for preventing flavor loss in a coffee extract by producing a liquid extract in the form of an ice cube. The method comprises the steps of extracting a concentrated coffee extract from the coffee powder by a conventional coffee extracting machine, and then subjecting the concentrated coffee extract to a low temperature environment in order to result in a concentrated extract in a solid state.

In another example, in U.S. Pat. No. 6,592,922, COFFEE AROMA RECOVERY PROECESS, to Furrer, et al., a coffee aroma recovery process is provided for collecting aroma components from coffee grounds to produce a coffee powder with an increased and improved aroma and flavor. The aroma component is captured as a gas, then reintegrated into a concentrated coffee extract prior to drying.

Despite these efforts to improve the quality and flavor of a concentrated coffee product, there remains a need for an instant coffee product with the full flavor, body, and aroma of a fresh brewed coffee product. Further, the instant coffee product should have none of the perceived stale, bitter, or off flavors associated by many with instant coffee.

Accordingly, as described herein, a method has been developed to prepare a cold-brewed instant coffee. This method involves the production of a coffee extract using a low temperature extraction of coffee grounds; this process can also be referred to as “cold-brewing”. The coffee extract can then be dried in order to preserve the flavor and aroma of the fresh brewed product. This method provides a concentrated coffee powder, or cold-brewed instant coffee, that produces a smooth and flavorful liquid coffee beverage upon the addition of water. The liquid coffee beverage produced from the instant coffee as disclosed herein additionally has improved aroma and low acidity.

Because the temperature used in the cold-brewing process is relatively low, the instant coffee powder produced via the method described herein, and the liquid coffee beverage produced from the instant coffee powder produced via the method described herein, will have attributes that differ from those of traditional freeze-dried or spray-dried instant coffee, including a number of advantages over other instant coffees. In particular, these include a number of advantages inherent to cold-brewed over hot-brewed coffee. These advantages are due to the avoidance of exposing the coffee grounds to high temperatures during the brewing process. The high processing temperatures to which coffee beans are subjected during roasting do not adversely affect the brewed product because the coffee beans are roasted whole but are brewed only after being ground.

There are many advantages of avoiding high temperatures in addition to the improved flavor of cold-brewed instant coffee relative to other instant coffees. For example, enzymes and antioxidants in food begin to deteriorate at 117° F. Coffee brewed at temperatures below 117° F. therefore has minimal enzymatic and antioxidant deterioration.

In addition, as described in Examples 1-5, cold-brewed coffee also has the advantages of reduced acidity and diterpene levels as compared to coffees produced via other methods. Many health benefits have been attributed to reduced acidity and diterpene levels.

Coffee naturally contains over 50 different acid compounds, which are present in varying amounts and degrees. Unfortunately, many people find that drinking coffee causes heartburn and intestinal distress due to the acid compounds in coffee. Acid levels vary with roasting temperatures and brewing temperatures, times, and techniques. The size of the grind also affects the levels and types of acid compounds in a finished cup of coffee.

Coffee also naturally contains diterpene compounds, which are of the terpene class of hydrocarbons. Terpenes generally tend to have strong scents, flavors, and essential oils, and residual diterpenes are among the substances that give coffee a slightly oily, bitter flavor.

Cafestol and kahweol are the two major diterpenes found in coffee beans. Cafestol is found in Coffea arabica in concentrations of approximately 0.6% by weight and is also present in Coffea robusta. Depending on how the beans are processed and brewed, cafestol is present in varying levels in the coffee itself Coffee that has been boiled has a much higher amount of cafestol; thus, French press and traditional Turkish coffee both have higher levels of cafestol than filtered coffees.

Unfortunately, studies have questioned the health effects of various diterpene compounds in coffee. For example, according to a recent study, cafestol may act as an agonist ligand for certain nuclear receptors, including the farnesoid X receptor and the pregnane X receptor, thereby blocking cholesterol homeostasis and resulting in raised cholesterol levels (Ricketts, et al. Mol. Endocrinol. 21:1603-16 (2007, Epub Apr. 24, 2007)).

Other studies have also indicated that cafestol elevates cholesterol levels, and some have concluded that cafestol can also elevate liver enzymes. For example, regular consumption of boiled coffee was found to increase serum cholesterol by 8% in men and 10% in women (results from National Toxicology Program (NTP): Cafestol (CASRN 469-83-0) and Kahweol (CASRN 6894-43-5)—Review of Toxicological Literature, October 1999).

Low cafestol levels can be about 0.15 mg % w/v or less, and sometimes about 0.09 mg % w/v or less, per 8 oz cup of coffee. A low cafestol coffee is defined as a coffee beverage that has less than half of the measurable cafestol than a coffee beverage prepared using the same starting coffee but prepared by a French press or drip coffee process. Low kahweol levels can be about 0.15 mg % w/v or less, and sometimes about 0.11 mg % w/v or less, per 8 oz cup of coffee preferable. A low kahweol coffee is defined as a coffee beverage that has less than half of the measurable kahweol than a coffee beverage prepared using the same starting coffee but prepared by a French press or drip coffee process.

The cold-brewed instant coffee, as described herein, produces a coffee beverage that has reduced acidity and diterpene levels.

### Coffee Beans

In some embodiments, the coffee beans are raw. In some embodiments, the coffee beans are roasted treated prior to being extracted via cold-brewing. In some embodiments, the coffee beans are freshly roasted.

The degree of the roast can be varied to produce a coffee extract having a desired strength and flavor. Various techniques and methods are known to those in the art for roasting coffee beans, including variable roasting temperatures, times, and methodologies. In the context of the present application, any type of roasted coffee beans can be utilized.

In some embodiments, the coffee beans are roasted within or close in proximity to the facility in which the cold-brewing process will be conducted. In some embodiments, the coffee beans are roasted immediately prior to the cold-brewing process. In some embodiments, the coffee beans are roasted within five minutes or fewer of the cold-brewing process. In some embodiments, the coffee beans are roasted within one hour or less of the cold-brewing process. In some embodiments, the coffee beans are roasted within one day or less of the cold-brewing process. In some embodiments, the coffee beans are roasted within one week or less of the cold-brewing process. In some embodiments, the coffee beans are roasted within one month or less of the cold-brewing process. In some embodiments, the coffee beans are roasted over one month prior to the cold-brewing process.

### Coffee Bean Grinding

In some embodiments, the roasted or raw coffee beans are ground into “coffee grounds” prior to cold-brewing. In some embodiments, the coffee grounds are ground into a mixture of uniform or non-uniform size. In some embodiments, the coffee beans are very coarsely ground. In some embodiments, the coffee beans are coarsely ground. In some embodiments, the coffee beans are intermediately ground. In some embodiments, the coffee beans are finely ground. In some embodiments, the coffee beans are very finely ground.

As is known to those in the art, the degree of the grind can be varied to produce a coffee extract having a desired strength and flavor, and different styles of coffee have different preferred or optimal grinds. The three most common grind types are fine, medium, and coarse. Coarsely ground coffee is generally used for various coffee brewing techniques and is commonly used for the press pot, or French press. Medium ground coffee is generally used in drip coffee makers, though the particle size of the medium grind can be varied, depending on the filter used with the coffee maker. Finely ground coffee is generally used for espresso-style coffee requires a fine grind, due to the extraction process. Turkish or Greek ground coffee can utilize grounds even finer than those used for espresso. A finer grind more easily releases the coffee components, resulting in greater flavor, but can potentially increase the acidity or produce more bitter or off flavors.

Various techniques and methods are known to those in the art for grinding coffee beans. In the context of the present application, any method for grinding roasted or unroasted coffee beans can be utilized. In the context of the present application, any type of grind, yielding any size of ground coffee, can be utilized.

In some embodiments, the coffee beans are ground within or close in proximity to the facility in which the cold-brewing process will be conducted. In some embodiments, the coffee beans are ground immediately prior to the cold-brewing process. In some embodiments, the coffee beans are ground within five minutes or fewer of the cold-brewing process. In some embodiments, the coffee beans are ground within one hour or less of the cold-brewing process. In some embodiments, the coffee beans are ground within one day or less of the cold-brewing process. In some embodiments, the coffee beans are ground within one week or less of the cold-brewing process. In some embodiments, the coffee beans are ground within one month or less of the cold-brewing process. In some embodiments, the coffee beans are ground over one month prior to the cold-brewing process.

As is known to those in the art, a number of factors can influence the mixture of flavors and other components in a coffee extraction. These include, for example, the temperature, the degree of agitation or movement of the water, the pressure applied to the grounds during the process (such as in a French press), and the like. Thus, while the common starting material of the coffee brewing process, namely roasted whole coffee beans, will have been subjected to high temperatures, the way the beans are processed during and after grinding greatly affects the amounts and kinds of components released into the water during the extraction, or brewing, process.

### Cold-Brewing Process

In embodiments of the invention, cold water is added to ground coffee beans to form a slurry, which is maintained (allowed to soak) at a low temperature for a period of time prior to being subject to a drying process. The process of subjecting the ground coffee beans to cold water is known as “cold-brewing” and allows soluble components from the ground coffee beans to be extracted into the water. Depending on the type of coffee beans or type of desired final coffee product, a shorter or longer soaking can be preferable.

In some embodiments, the slurry is prepared with water having a temperature of less than 117° F. In some embodiments, the slurry is prepared with water having a temperature of less than 106° F. In some embodiments, the slurry is prepared with water having a temperature of less than 90° F. In some embodiments, the slurry is prepared with water having a temperature of less than 70° F. In some embodiments, the slurry is prepared with water having a temperature of less than 50° F.

In some embodiments, the slurry is prepared with water having a temperature of less than 117° F., 116° F., 115° F., 114° F., 113° F., 112° F., 111° F., or 110° F. In some embodiments, the slurry is prepared with water having a temperature of less than 109° F., 108° F., 107° F., 106° F., 105° F., 104° F., 103° F., 102° F., 101° F., or 100° F. In some embodiments, the slurry is prepared with water having a temperature of less than 99° F., 98° F., 97° F., 96° F., 95° F., 94° F., 93° F., 92° F., 91° F., or 90° F. In some embodiments, the slurry is prepared with water having a temperature of less than 89° F., 88° F., 87° F., 86° F., 85° F., 84° F., 83° F., 82° F., 81° F., or 80° F. In some embodiments, the slurry is prepared with water having a temperature of less than 79° F., 78° F., 77° F., 76° F., 75° F., 74° F., 73° F., 72° F., 71° F., or 70° F. In some embodiments, the slurry is prepared with water having a temperature of less than 69° F., 68° F., 67° F., 66° F., 65° F., 64° F., 63° F., 62° F., 61° F., or 60° F. In some embodiments, the slurry is prepared with water having a temperature of less than 59° F., 58° F., 57° F., 56° F., 55° F., 54° F., 53° F., 52° F., 51° F., or 50° F. In some embodiments, the slurry is prepared with water having a temperature of less than 49° F., 48° F., 47° F., 46° F., 45° F., 44° F., 43° F., 42° F., 41° F., or 40° F.

The slurry can be maintained at a temperature and for a sufficient length of time to result in the optimal release of coffee flavors. Sub-optimal temperatures and longer times can risk an increase in bitter or off flavors.

In some embodiments, the slurry is maintained at a temperature below 117° F. In some embodiments, the slurry is maintained at a temperature below 106° F. In some embodiments, the slurry is maintained at a temperature below 90° F. In some embodiments, the slurry is maintained at a temperature below 70° F. In some embodiments, the slurry is maintained at a temperature below 50° F.

In some embodiments, the slurry is maintained at a temperature below 117° F., 116° F., 115° F., 114° F., 113° F., 112° F., 111° F., or 110° F. In some embodiments, the slurry is maintained at a temperature below 109° F., 108° F., 107° F., 106° F., 105° F., 104° F., 103° F., 102° F., 101° F., or 100° F. In some embodiments, the slurry is maintained at a temperature below 99° F., 98° F., 97° F., 96° F., 95° F., 94° F., 93° F., 92° F., 91° F., or 90° F. In some embodiments, the slurry is maintained at a temperature below 89° F., 88° F., 87° F., 86° F., 85° F., 84° F., 83° F., 82° F., 81° F., or 80° F. In some embodiments, the slurry is maintained at a temperature below 79° F., 78° F., 77° F., 76° F., 75° F., 74° F., 73° F., 72° F., 71° F., or 70° F. In some embodiments, the slurry is maintained at a temperature below 69° F., 68° F., 67° F., 66° F., 65° F., 64° F., 63° F., 62° F., 61° F., or 60° F. In some embodiments, the slurry is maintained at a temperature below 59° F., 58° F., 57° F., 56° F., 55° F., 54° F., 53° F., 52° F., 51° F., or 50° F. In some embodiments, the slurry is maintained at a temperature below 49° F., 48° F., 47° F., 46° F., 45° F., 44° F., 43° F., 42° F., 41° F., or 40° F.

In some embodiments, the slurry is maintained for at least one hour. In some embodiments, the slurry is maintained for more than one hour. In some embodiments, the slurry is maintained for 6 hours or more. In some embodiments, the slurry is maintained for 12 hours or more. In some embodiments, the slurry is maintained for 18 hours or more. In some embodiments, the slurry is maintained for 24 hours or more. In some embodiments, the slurry is maintained for 30 hours or more. In some embodiments, the slurry is maintained for 36 hours or more. In some embodiments, the slurry is maintained for 48 hours or more. In some embodiments, the slurry is maintained for 60 hours or more.

In some embodiments, the slurry is maintained for 1, 2, 3, 4, 5, 6, 7, 8, or 9 hours or more. In some embodiments, the slurry is maintained for 10, 11, 12, 13, 14, 15, 16, 17, 18, or 19 hours or more. In some embodiments, the slurry is maintained for 20, 21, 22, 23, 24, 25, 26, 27, 28, or 29 hours or more. In some embodiments, the slurry is maintained for 30, 31, 32, 33, 34, 35, 36, 37, 38, or 39 hours or more. In some embodiments, the slurry is maintained for 40, 41, 42, 43, 44, 45, 46, 47, 48, or 49 hours or more. In some embodiments, the slurry is maintained for 50, 51, 52, 53, 54, 55, 56, 57, 58, 59, or 60 hours or more.

In some embodiments, the slurry is maintained for one week or more. In some embodiments, the slurry is maintained for two weeks or more.

Movement of water over the grounds or the introduction of agitation in the process can impact the strength of the coffee. In addition, such agitation can affect the amounts and types of compounds in the coffee extract, both desired and not desired.

In some embodiments, the slurry is not allowed to be agitated. In some embodiments, the slurry is subject to minimal agitation. In some embodiments, the slurry is gently agitated. In some embodiments, the slurry is moderately agitated. In some embodiments, the slurry is considerably agitated.

In some embodiments, the agitation occurs for less than 1, 2, 3, 4, 5, 6, 7, 8, 9, or 10 hours. In some embodiments, the agitation occurs for less than 11, 12, 13, 14, 15, 16, 17, 18, 19, or 10 hours. In some embodiments, the agitation occurs for less than 21, 22, 23, 24, 25, 26, 27, 28, 29, or 30 hours. In some embodiments, the agitation occurs for 30 hours or more. In some embodiments, the agitation occurs for the duration of the cold-brewing process.

The amount of acid in the produced from the instant coffee powder can be reduced by reducing the temperature of the water added to prepare the slurry and by reducing the temperature at which the slurry is maintained. This temperature can be maintained for any length of time during the cold-brewing process. Assessments of the acid levels in the slurry can be made at any point during the cold-brewing process.

In some embodiments, the amount of acid in the liquid coffee beverage produced from the instant coffee powder is reduced by preparing the slurry with water having a temperature of less than 106° F. In some embodiments, the amount of acid in the liquid coffee beverage produced from the instant coffee powder is reduced by preparing the slurry with water having a temperature of less than 90° F. In some embodiments, the amount of acid in the liquid coffee beverage produced from the instant coffee powder is reduced by preparing the slurry with water having a temperature of less than 70° F. In some embodiments, the amount of acid in the liquid coffee beverage produced from the instant coffee powder is reduced by preparing the slurry with water having a temperature of less than 50° F.

In some embodiments, the amount of acid in the liquid coffee beverage produced from the instant coffee powder is reduced by maintaining the slurry at a temperature of less than 106° F. In some embodiments, the amount of acid in the liquid coffee beverage produced from the instant coffee powder is reduced by maintaining the slurry at a temperature of less than 90° F. In some embodiments, the amount of acid in the liquid coffee beverage produced from the instant coffee powder is reduced by maintaining the slurry at a temperature of less than 70° F. In some embodiments, the amount of acid in the liquid coffee beverage produced from the instant coffee powder is reduced by maintaining the slurry at a temperature of less than 50° F.

The ratio of coffee grounds to water can be optimized to provide the most complete extraction possible of flavor. The ratio can be varied. For example, a relatively low water content can be used in order to simplify the water removal process. In some embodiments, the ratio of coffee grounds to water is 5 pounds coffee grounds to 3 gallons water.

In some embodiments, the ratio of coffee grounds to water is at least 0.1 pounds coffee grounds to 3 gallons water. In some embodiments, the ratio of coffee grounds to water is at least 0.5 pounds coffee grounds to 3 gallons water. In some embodiments, the ratio of coffee grounds to water is at least 1 pound coffee grounds to 3 gallons water. In some embodiments, the ratio of coffee grounds to water is at least 2 pounds coffee grounds to 3 gallons water. In some embodiments, the ratio of coffee grounds to water is at least 4 pounds coffee grounds to 3 gallons water. In some embodiments, the ratio of coffee grounds to water is at least 5 pounds coffee grounds to 3 gallons water. In some embodiments, the ratio of coffee grounds to water is at least 10 pounds coffee grounds to 3 gallons water. In some embodiments, the ratio of coffee grounds to water is at least 15 pounds coffee grounds to 3 gallons water.

### Cold-Brew Processing Apparatus

Various techniques and apparatuses are known in the art for cold-brewing coffee. For example, U.S. Pat. No. 7,858,133, COLD BREW COFFEE MAKER, to Neace, et al., provides an apparatus for cold brewing coffee at a batch level, wherein the water and coffee grounds are combined in a chamber for an extended period without agitation or water movement. The extract is then decanted from the contained grounds to provide a coffee extract. In another example, U.S. Pat. No. 2,878,746, COLD WATER COFFEE BREWER, to Schwinger, discloses a small batch device for brewing coffee with cold water, comprising a large canister into which coffee grounds are placed and through which cold water is circulated. U.S. Pat. No. 4,112,830, EXTRACTING BLACK TEA AND COFFEE AND CLOSED EXTRACTOR THEREFOR, to Saito, discloses a similar device using cold water to obtain an extraction.

For large or continuous batches of coffee, a stainless steel vat common to the industry and well known to the art can be employed. Means for controlling the temperature and water movement within the slurry can be provided, allowing precise control of the cold-brewing process.

The invention disclosed herein can be practiced using any of the above described apparatuses, or similar versions, or modified versions. The invention disclosed herein can also be practiced using any type of suitable apparatus, as will be understood by those of skill in the art.

### Isolation of the Liquid Coffee Extract

Once the cold-brewing process is complete, the slurry is separated into its solid and liquid components in order to isolate the liquid coffee extract from the spend grounds. Various methods are known in the art to separate the solids from the liquid extract, such as, for example, filtering, decanting, pressing, centrifuging, pressurizing and extracting with air, pressurizing and extracting with steam, and the like.

The invention disclosed herein can be practiced using any of the above described separation methods, or any of a wide range of other appropriate methods, as are well-known to those of skill in the art.

### Drying Process

After isolation, the liquid coffee extract, containing water and the soluble components, is dried to yield a powdered coffee extract that can be packaged and sold as an instant coffee product. The use of low and controlled temperatures can allow for the specific removal of water molecules, while maintaining the nutrients and flavor and aroma compounds, thereby resulting in a full, flavorful, free-flowing instant coffee powder with full coffee taste and aroma, as well as a long shelf life.

The drying process can occur via any of a number of known processes capable of removing water from a liquid extract. These include, for example, freeze drying, spray drying, centrifugation, vacuum drying, use of radiant heat, drying at ambient temperatures, application of infrared heat, evaporation, drum drying, dehydration, shelf drying, solar drying, and the like.

In some embodiments, the drying process results in a coffee extract with a water content of less than 25%. In some embodiments, the drying process results in a coffee extract with a water content of less than 15%. In some embodiments, the drying process results in a coffee extract with a water content of less than 10%. In some embodiments, the drying process results in a coffee extract with a water content of less than 5%. In some embodiments, the drying process results in a coffee extract with a water content of less than 3%. In some embodiments, the drying process results in a coffee extract with a water content of less than 1%.

The temperature and duration of the drying process can be controlled so as to prevent degradation of the soluble components. Many of the drying systems known for producing powders from liquid systems allow for a low temperature, for example, below 117° F., or an ambient temperature to be maintained throughout the drying process. In other drying systems, exposure to temperatures above 117° F. can be controlled to very short periods of time during the drying process in order to prevent the breakdown of soluble components or to prevent the loss of aroma and flavor components in the extract. The drying process can also employ one or more sensors in order to provide feedback for the regulation of the temperature of the heat source and the moisture of the drying atmosphere in order to maintain a controlled environment.

In some embodiments, the drying process utilizes a sensor that is configured to detect and measure the extract temperature and moisture content. In some embodiments, the sensor allows the temperature of the drying process to be maintained below about 117° F.

Higher temperature techniques can be utilized for ease or speed of processing. In such cases, the higher temperature can be maintained for only a short period of time; alternatively, the higher temperature can be maintained for an extended period of time.

In one exemplary drying process, the liquid coffee extract can be initially frozen via freeze drying. The frozen mixture can then be subjected to a vacuum and an infrared process, during which heat is applied.

In another exemplary drying process, the liquid coffee extract can be dried via conventional spray drying processes. Although such processes can heat the liquid coffee extract at temperatures up to and above 160° F., the spray drying process can be completed in a very short period of time in order to minimize exposure to the high temperature. For example, the process can be conducted over a period of, for example, 5-30 seconds, depending on factors such as temperature, particle size, and drying chamber diameter.

In another exemplary drying process, U.S. Pat. No. 6,539,645, DRYING APPARATUS AND METHODS, and its divisional, U.S. Pat. No. 7,441,344, DRYING APPARATUS AND METHODS, both to Savarese, disclose a drying apparatus and methods for drying a product by directing a dry radiant heat, such as infrared heat, toward the second side of the surface to heat the product. Using an infrared source provides heat that is directly absorbed by the water in the concentrate, allowing for the rapid removal of water to be accomplished without deleterious chemical reactions. Such a process can be completed before microbial growth can occur, thereby preventing microbial degradation of the product. In such a case, no additional sterilization process for the final powdered product would be required.

The drying process can be conducted at ambient temperatures. For purposes of this description, a drying process is conducted at ambient heat if is carried out at temperatures of less than about 90° F. Such an ambient process can produce powders that retain their natural qualities when reconstituted in water.

Ambient processes can be particularly useful in preventing degradation of color, flavor, aroma, enzymes, and nutritional compounds. This is because the relatively low ambient temperatures dry and stabilize the product without altering or denaturing unstable compounds. Further, by the use of a carbon dioxide gas shield, products can be protected from oxidization during the most delicate stages of drying.

For example, LiquaDry (Abraham, Utah) has developed an ambient temperature drying process capable of dehydrating any liquid or slurry into a powder. The product typically reaches a maximum temperature of only 41° C./106° F.

The invention disclosed herein can be practiced using any of the above described drying processes, or any of a wide range of other appropriate methods, as are well-known to those of skill in the art, or any combination of the above-described or other appropriate methods. In some embodiments, the liquid coffee extract is dried via freeze drying. In some embodiments, the liquid coffee extract is dried via spray drying. In some embodiments, the liquid coffee extract is dried via centrifugation. In some embodiments, the liquid coffee extract is dried via vacuum drying. In some embodiments, the liquid coffee extract is dried via radiant heat. In some embodiments, the liquid coffee extract is dried via ambient temperatures. In some embodiments, the liquid coffee extract is dried via application of infrared heat. In some embodiments, the liquid coffee extract is dried via drum drying. In some embodiments, the liquid coffee extract is dried via dehydration. In some embodiments, the liquid coffee extract is dried via shelf drying. In some embodiments, the liquid coffee extract is dried via solar drying.

In some embodiments, the temperature during the drying process is maintained in part or throughout the drying process at or below 117° F. In some embodiments, the temperature during the drying process is maintained in part or throughout the drying process at or below 106° F. In some embodiments, the temperature during the drying process is maintained in part or throughout the drying process at or below 90° F. In some embodiments, the temperature during the drying process is maintained in part or throughout the drying process at or below 65° F. In some embodiments, the temperature during the drying process is maintained in part or throughout the drying process at or below 50° F.

In some embodiments, the temperature during the drying process can be above 117° F. In some embodiments, the temperature during the drying process can be above 117° F. for a period of less than 2 seconds. In some embodiments, the temperature during the drying process can be above 117° F. for a period of less than 5 seconds. In some embodiments, the temperature during the drying process can be above 117° F. for a period of less than 30 seconds. In some embodiments, the temperature during the drying process can be above 117° F. for a period of less than 45 seconds. In some embodiments, the temperature during the drying process can be above 117° F. for a period of less than 1 minute. In some embodiments, the temperature during the drying process can be above 117° F. for a period of less than 5 minutes.

In some embodiments, the temperature during the drying process can be above 117° F. for over 5 minutes. In some embodiments, the temperature during the drying process can be above 117° F. for over one hour. In some embodiments, the temperature during the drying process can be above 117° F. for over one day.

Accordingly, the cold-brewed coffee extract prepared as described herein can be produced through a drying process that dries coffee quickly and can utilize temperatures above 117° F. for less than the entirety of the drying process. Such drying processes can reduce or prevent heat degradation of the final product, such that the taste profile of the liquid coffee beverage produced from the instant coffee powder will more closely approximate the cold brew flavor. Temperatures above 117° F. can be utilized for extended periods of time as well.

The length of time required for drying the liquid coffee extract can vary, depending on the flow rate and the solids content of the liquid coffee extract. A liquid coffee extract with a high solids content can be dried with faster drying times and flow rates. Embodiments of the invention can allow the drying process to be carried out for any length of time sufficient to remove water content from the liquid coffee extract.

### Cold-Brewed Instant Coffee Blends

The cold-brewed instant coffee, as described herein, can be mixed, or blended, with other powders that are used to produce beverages upon the addition of water. Blending the cold-brewed instant coffee with other powders used to produce beverages upon the addition of water can result in a mixture that yields a beverage with coffee characteristics, including flavors and aromas. In addition, these beverages will have the additional health benefits of cold-brewed coffee as compared to conventional coffee, including reduced acidity and reduced diterpene levels.

For example, the cold-brewed instant coffee can be blended with other types of instant coffee, such as, for example, hot-brewed instant coffee, other commercially available instant coffees, and the like. Such a blend will yield a mixture that, upon the addition of water, produces a beverage with improved coffee characteristics, including flavors and aromas. The coffee characteristics, including flavors and aromas, of the beverages made from the instant coffee mixtures produced in this manner are improved over those of other instant coffee powders alone due to the inherent beneficial qualities of the cold-brewed instant coffee, as described previously. An exemplary mixture ratio can be, for example, 51% cold-brewed instant coffee and 49% other instant coffee. Those in the art will recognize that any other ratio can be utilized to yield a desired flavor profile.

In another example, the cold-brewed instant coffee can be blended with cacao and/or cocoa, which is the processed form of cacao, to yield a mixture that, upon the addition of water, produces a beverage with coffee characteristics, including flavors and aromas, in addition to those of cocoa. Coffee beverages that are mixed with cacao or cocoa are commonly termed “mocha” beverages. The coffee characteristics, including flavors and aromas, of the beverages made from the instant mocha powders produced in this manner are improved over those of other instant mocha powders due to the inherent beneficial qualities of the cold-brewed instant coffee, as described previously. An exemplary mixture ratio can be, for example, 51% cocoa and/or cacao and 49% cold-brewed instant coffee. Those in the art will recognize that any other ratio can be utilized to yield a desired flavor profile.

In another example, the cold-brewed instant coffee can be blended with cacao and/or cocoa, as well as other types of instant coffee. An exemplary mixture ratio can be, for example, 51% cocoa and/or cacao, 25% cold-brewed instant coffee, and 24% other instant coffee. Those in the art will recognize that any other ratio can be utilized to yield a desired flavor profile.

In some embodiments, cold-brewed instant coffee is blended with one or more other instant coffee, wherein the percentage of cold-brewed instant coffee is 5% or higher. In some embodiments, cold-brewed instant coffee is blended with one or more other instant coffee, wherein the percentage of cold-brewed instant coffee is 25% or higher. In some embodiments, cold-brewed instant coffee is blended with one or more other instant coffee, wherein the percentage of cold-brewed instant coffee is 50% or higher. In some embodiments, cold-brewed instant coffee is blended with one or more other instant coffee, wherein the percentage of cold-brewed instant coffee is 75% or higher.

In some embodiments, cold-brewed instant coffee is blended with one or more other instant coffee, wherein the percentage of cold-brewed instant coffee is 1%, 2%, 3%, 4%, 5%, 6%, 7%, 8%, 9%, 10%, or higher. In some embodiments, cold-brewed instant coffee is blended with one or more other instant coffee, wherein the percentage of cold-brewed instant coffee is 11%, 12%, 13%, 14%, 15%, 16%, 17%, 18%, 19%, 20%, or higher. In some embodiments, cold-brewed instant coffee is blended with one or more other instant coffee, wherein the percentage of cold-brewed instant coffee is 21%, 22%, 23%, 24%, 25%, 26%, 27%, 28%, 29%, 20%, or higher. In some embodiments, cold-brewed instant coffee is blended with one or more other instant coffee, wherein the percentage of cold-brewed instant coffee is 31%, 32%, 33%, 34%, 35%, 36%, 37%, 38%, 39%, 40%, or higher. In some embodiments, cold-brewed instant coffee is blended with one or more other instant coffee, wherein the percentage of cold-brewed instant coffee is 41%, 42%, 43%, 44%, 45%, 46%, 47%, 48%, 49%, 50%, or higher. In some embodiments, cold-brewed instant coffee is blended with one or more other instant coffee, wherein the percentage of cold-brewed instant coffee is 51%, 52%, 53%, 54%, 55%, 56%, 57%, 58%, 59%, 60%, or higher. In some embodiments, cold-brewed instant coffee is blended with one or more other instant coffee, wherein the percentage of cold-brewed instant coffee is 61%, 62%, 63%, 64%, 65%, 66%, 67%, 68%, 69%, 70%, or higher. In some embodiments, cold-brewed instant coffee is blended with one or more other instant coffee, wherein the percentage of cold-brewed instant coffee is 71%, 72%, 73%, 74%, 75%, 76%, 77%, 78%, 79%, 80%, or higher. In some embodiments, cold-brewed instant coffee is blended with one or more other instant coffee, wherein the percentage of cold-brewed instant coffee is 81%, 82%, 83%, 84%, 85%, 86%, 87%, 88%, 89%, 90%, or higher. In some embodiments, cold-brewed instant coffee is blended with one or more other instant coffee, wherein the percentage of cold-brewed instant coffee is 91%, 92%, 93%, 94%, 95%, 96%, 97%, 98%, 99%, or higher.

In some embodiments, cold-brewed instant coffee is blended with cacao and/or cocoa, wherein the percentage of cold-brewed instant coffee is 5% or higher. In some embodiments, cold-brewed instant coffee is blended with cacao and/or cocoa, wherein the percentage of cold-brewed instant coffee is 25% or higher. In some embodiments, cold-brewed instant coffee is blended with cacao and/or cocoa, wherein the percentage of cold-brewed instant coffee is 50% or higher. In some embodiments, cold-brewed instant coffee is blended with cacao and/or cocoa, wherein the percentage of cold-brewed instant coffee is 75% or higher.

In some embodiments, cold-brewed instant coffee is blended with cacao and/or cocoa, wherein the percentage of cold-brewed instant coffee is 1%, 2%, 3%, 4%, 5%, 6%, 7%, 8%, 9%, 10%, or higher. In some embodiments, cold-brewed instant coffee is blended with cacao and/or cocoa, wherein the percentage of cold-brewed instant coffee is 11%, 12%, 13%, 14%, 15%, 16%, 17%, 18%, 19%, 20%, or higher. In some embodiments, cold-brewed instant coffee is blended with cacao and/or cocoa, wherein the percentage of cold-brewed instant coffee is 21%, 22%, 23%, 24%, 25%, 26%, 27%, 28%, 29%, 20%, or higher. In some embodiments, cold-brewed instant coffee is blended with cacao and/or cocoa, wherein the percentage of cold-brewed instant coffee is 31%, 32%, 33%, 34%, 35%, 36%, 37%, 38%, 39%, 40%, or higher. In some embodiments, cold-brewed instant coffee is blended with cacao and/or cocoa, wherein the percentage of cold-brewed instant coffee is 41%, 42%, 43%, 44%, 45%, 46%, 47%, 48%, 49%, 50%, or higher. In some embodiments, cold-brewed instant coffee is blended with cacao and/or cocoa, wherein the percentage of cold-brewed instant coffee is 51%, 52%, 53%, 54%, 55%, 56%, 57%, 58%, 59%, 60%, or higher. In some embodiments, cold-brewed instant coffee is blended with cacao and/or cocoa, wherein the percentage of cold-brewed instant coffee is 61%, 62%, 63%, 64%, 65%, 66%, 67%, 68%, 69%, 70%, or higher. In some embodiments, cold-brewed instant coffee is blended with cacao and/or cocoa, wherein the percentage of cold-brewed instant coffee is 71%, 72%, 73%, 74%, 75%, 76%, 77%, 78%, 79%, 80%, or higher. In some embodiments, cold-brewed instant coffee is blended with cacao and/or cocoa, wherein the percentage of cold-brewed instant coffee is 81%, 82%, 83%, 84%, 85%, 86%, 87%, 88%, 89%, 90%, or higher. In some embodiments, cold-brewed instant coffee is blended with cacao and/or cocoa, wherein the percentage of cold-brewed instant coffee is 91%, 92%, 93%, 94%, 95%, 96%, 97%, 98%, 99%, or higher.

In some embodiments, cold-brewed instant coffee is blended with cacao that has been processed at temperatures below 150° F. In some embodiments, cold-brewed instant coffee is blended with cacao that has been processed at temperatures below 120° F. In some embodiments, cold-brewed instant coffee is blended with cacao that has been processed at temperatures below 100° F. In some embodiments, cold-brewed instant coffee is blended with cacao that has been processed at temperatures below 80° F.

In some embodiments, cold-brewed instant coffee is blended with one or more other instant coffee and cacao and/or cocoa, wherein the percentage of cold-brewed instant coffee is 1%, 2%, 3%, 4%, 5%, 6%, 7%, 8%, 9%, 10%, or higher. In some embodiments, cold-brewed instant coffee is blended with one or more other instant coffee and cacao and/or cocoa, wherein the percentage of cold-brewed instant coffee is 11%, 12%, 13%, 14%, 15%, 16%, 17%, 18%, 19%, 20%, or higher. In some embodiments, cold-brewed instant coffee is blended with one or more other instant coffee and cacao and/or cocoa, wherein the percentage of cold-brewed instant coffee is 21%, 22%, 23%, 24%, 25%, 26%, 27%, 28%, 29%, 20%, or higher. In some embodiments, cold-brewed instant coffee is blended with one or more other instant coffee and cacao and/or cocoa, wherein the percentage of cold-brewed instant coffee is 31%, 32%, 33%, 34%, 35%, 36%, 37%, 38%, 39%, 40%, or higher. In some embodiments, cold-brewed instant coffee is blended with one or more other instant coffee and cacao and/or cocoa, wherein the percentage of cold-brewed instant coffee is 41%, 42%, 43%, 44%, 45%, 46%, 47%, 48%, 49%, 50%, or higher. In some embodiments, cold-brewed instant coffee is blended with one or more other instant coffee and cacao and/or cocoa, wherein the percentage of cold-brewed instant coffee is 51%, 52%, 53%, 54%, 55%, 56%, 57%, 58%, 59%, 60%, or higher. In some embodiments, cold-brewed instant coffee is blended with one or more other instant coffee and cacao and/or cocoa, wherein the percentage of cold-brewed instant coffee is 61%, 62%, 63%, 64%, 65%, 66%, 67%, 68%, 69%, 70%, or higher. In some embodiments, cold-brewed instant coffee is blended with one or more other instant coffee and cacao and/or cocoa, wherein the percentage of cold-brewed instant coffee is 71%, 72%, 73%, 74%, 75%, 76%, 77%, 78%, 79%, 80%, or higher. In some embodiments, cold-brewed instant coffee is blended with one or more other instant coffee and cacao and/or cocoa, wherein the percentage of cold-brewed instant coffee is 81%, 82%, 83%, 84%, 85%, 86%, 87%, 88%, 89%, 90%, or higher. In some embodiments, cold-brewed instant coffee is blended with one or more other instant coffee and cacao and/or cocoa, wherein the percentage of cold-brewed instant coffee is 91%, 92%, 93%, 94%, 95%, 96%, 97%, 98%, 99%, or higher.

In an exemplary embodiment of the invention, coffee beans are freshly roasted, then freshly ground. The ground roasted coffee is then cold brewed by adding water at a temperature of less than 117° F. to the coffee grounds, in a ratio of 5 pounds coffee grounds to 3 gallons water, to produce a slurry. The slurry is then maintained for about 18 to 24 hours at 117° F. or below. The slurry is then filtered to yield a liquid coffee extract, which is then dried at a temperature of 117° F. or below to yield an instant coffee powder.

In this manner, an instant coffee can be produced that, upon the addition of water, yields a liquid coffee beverage that is full-flavored and low in acid. The instant coffee produced as described herein can be packaged, shipped, and delivered to a consumer for the preparation of a healthful, full-bodied, and low in acid liquid coffee beverage at a consumer's residence or a retail establishment.

The utilization of the cold-brewing process to prepare the instant coffee allows for a liquid coffee beverage that is lower in tannin acid equivalents, overall acidic content, and diterpene levels. The instant coffee prepared in the manner as described herein can be blended with other powders to which water can be added to produce a beverage, thereby allowing for the production of beverages having improved coffee characteristics, including flavors and aromas.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

In the examples that follow, the components of various coffee brewing preparations were analyzed and compared. Laboratory tests were performed using roasted coffee beans were purchased from Starbucks®.

### Example 1

### Diterpene Levels in Cold-Brewed Coffee as Compared to Hot-Brewed Coffee

A study was designed to determine the levels of the diterpenes, cafestol and kahweol, in cold-brewed coffee as compared to coffee prepared by conventional hot-brewed methods, including hot-brewed coffee prepared via French press and espresso maker. Coarsely ground coffee was used to test for levels of cafestol and kahweol in coffee brewed by the French press method and the cold-brewed method. Finely ground coffee was used to test for levels of cafestol and kahweol in coffee prepared in an espresso maker.

In each case, hot-brewed coffee was prepared in accordance with the instructions supplied by the coffee makers. Cold-brewed coffee was prepared utilizing the device described in United States Patent Application No. 20080148955, APPARATUS FOR EXTRACTING COLD-BREWED COFFEE CONCENTRATE, to Neace, et al., and according to the method described herein, in which a slurry with a ratio of 5 pounds coffee grounds to 3 gallons of water was maintained at ambient temperature for 24 hours, followed by gravity filtration, hereafter collectively referred to as “the Neace cold brew method,” using coarsely ground coffee.

Coffee starting volumes and weights were standardized. The resulting cups of brewed coffee were analyzed for cafestol and kahweol using high pressure liquid chromatography with mass spectroscopy detection (HPLC/MS). The results are presented in terms of the weight in milligrams of the diterpene compound as a component of the total liquid volume of the brewed coffee, as shown in Table 1.

TABLE 1

| Analyte | Preparation Method | Result |
|---|---|---|
| Cafestol | Neace cold brew | 0.09 mg % w/v |
| Cafestol | French press - hot | 0.75 mg % w/v |
| Cafestol | Espresso - hot | 0.50 mg % w/v |
| Kahweol | Neace cold brew | 0.11 mg % w/v |
| Kahweol | French press - hot | 1.67 mg % w/v |
| Kahweol | Espresso - hot | 0.32 mg % w/v |

As shown in Table 1, cold-brewed coffee prepared according to the Neace cold brew method had lower concentrations of both cafestol and kahweol than coffee prepared by either of the hot brew methods. The cold-brewed method produced coffee with 88% less cafestol and 93% less kahweol than hot-brewed coffee prepared using the French press method. The cold-brewed coffee had 82% less cafestol and 66% less kahweol than hot-brewed coffee prepared using an espresso maker.

### Example 2

### Diterpene Levels in Cold-Brewed Coffee Prepared Via Different Methods

In a subsequent study, the effects of the cold brewing process were evaluated. Diterpene levels were determined in cold-brewed coffee prepared according to the Neace cold brew method and were compared to diterpene levels of coffee brewed by the French press method using cold water.

Coffee starting volumes and weights were standardized. The resulting cups of brewed coffee were analyzed for cafestol and kahweol using HPLC/MS. The results are presented in terms of the weight in milligrams of the diterpene compound as a component of the total liquid volume of the brewed coffee, as shown in Table 2.

TABLE 2

| Analyte | Preparation | Result |
|---|---|---|
| Cafestol | Neace cold brew | 0.07 mg % w/v |
| Cafestol | French press - cold | 0.24 mg % w/v |
| Kahweol | Neace cold brew | 0.03 mg % w/v |
| Kahweol | French press - cold | 0.16 mg % w/v |

Cold-brewed coffee prepared according to the Neace cold brew method was found to have 71% less cafestol and 81% less kahweol than coffee brewed by the French press method using cold water.

### Example 3

### Titratable Acidity in Cold-Brewed Coffee Prepared Via Different Methods

In a subsequent study, the effects of the cold brewing process were further evaluated. Acidity levels were determined in cold-brewed coffee prepared according to the Neace cold brew method and were compared to acidity levels of coffee brewed by the French press method using cold water and coarsely ground coffee.

Coffee starting volumes and weights were standardized. The resulting cups of brewed coffee were titrated for acidity levels, a measure of acid compounds in the coffee, by measuring the milliliters of a 0.1 N alkali solution required to neutralize acidity in an 8 oz coffee sample. The results are shown in Table 3.

TABLE 3

| Preparation Method | Result |
|---|---|
| Neace cold brew | 8.6 mL/8 oz |
| French press - cold | 12.1 mL/8 oz |

Cold-brewed coffee prepared according to the Neace cold brew method was found to have a total acidity that was 29% lower than that of coffee brewed by the French press method using cold water.

### Example 4

### Titratable Acidity in Cold-Brewed Coffee as Compared to Drip Coffee

According to the same method as described in Example 3, acidity levels were determined in cold-brewed coffee prepared according to the Neace cold brew method and were compared to acidity levels of coffee brewed via the standard drip percolation method with hot water, according to the manufacturer's instructions.

Cold-brewed coffee prepared according to the Neace cold brew method was found to have a total acidity that was 69.6% lower than that of coffee prepared via the drip percolation method.

### Example 5

### Tannic Acid Equivalents in Cold-Brewed Coffee as Compared to Drip Coffee

Tannins are polyphenols that are commonly found in various plants and plant-derived foods and beverages, including tea and coffee. Coffee contains various tannins, and various methods are known that can be used to assay the tannins in coffee. These include spectrophotometric methods for providing a weight percentage in assayed “tannic acid equivalents.” Tannic acid is a specific commercial form of tannin.

Accordingly, in a subsequent study, the effects of the cold brewing process were further evaluated. Tannic acid equivalents were determined in cold-brewed coffee prepared according to the Neace cold brew method and were compared to acidity levels of coffee brewed via the standard drip percolation method with hot water.

Cold brewed coffee prepared according to the Neace cold brew method was found to be 58% lower in tannic acid equivalents than coffee prepared via the drip percolation method.

### Example 6

### Method for Preparation of Cold-Brewed Instant Coffee

Coffee beans were roasted, then ground. The ground roasted coffee was then cold brewed by adding water at a temperature of less than 117° F. to the coffee grounds to produce a slurry, using 5 pounds coffee grounds to 3 gallons water. The slurry was then maintained for about 18 to 24 hours at 117° F. or below. The slurry was then filtered to yield a liquid coffee extract.

A drying process was applied to the liquid coffee extract obtained from the cold brew process described above. The extract was dried via spray drying at below 115° F. for 2-4 minutes, to produce a powdered, shelf-stable cold-brewed instant coffee with less than 5% water content.

The powdered cold-brewed instant coffee was vacuum packaged to result in a stable cold-brewed instant coffee product. This product can have a shelf life of 2-3 years or more, when maintained at room temperature.

### Example 7

### Coffee Beverage Prepared from Cold-Brewed Instant Coffee

A coffee beverage was prepared by adding water to the cold-brewed instant coffee of Example 6. The instant coffee dissolved readily and completely to produce the coffee beverage.

The beverage had a full bodied flavor with none of the bitter or off flavors of conventional instant coffee. The product had the coffee taste and aroma of fresh cold brewed coffee.

### Example 8

### Coffee Beverage Prepared from Blend of Cold-Brewed Instant Coffee and Other Instant Coffee

The cold-brewed instant coffee was blended with an instant coffee that was prepared via a conventional hot-brewing process. The cold-brewed instant coffee was blended with the hot-brewed instant coffee in a ratio of 51% cold-brewed instant coffee to 49% hot-brewed instant coffee.

Upon the addition of water, a coffee beverage was produced that had enhanced coffee characteristics, including improved flavor and aromas, as compared to the coffee beverage prepared from the hot-brewed instant coffee alone.

### Example 9

### Mocha Beverage Prepared from Blend of Cold-Brewed Instant Coffee, Cocoa, and Other Instant Coffee

The cold-brewed instant coffee was blended with a cold-processed cacao and an instant coffee that was prepared via a conventional hot-brewing process. The cold-brewed instant coffee was blended with the cold-processed cacao and the hot-brewed instant coffee in a ratio of 51% cacao to 25% cold-brewed instant coffee to 24% hot-brewed instant coffee.

Upon the addition of water, a mocha beverage was produced that had enhanced coffee characteristics, including improved flavor and aromas, as compared to the mocha beverage prepared from only the cacao and the hot-brewed instant coffee.

### Example 10

### General Method for Preparation of Cold-Brewed Instant Coffee

In an exemplary embodiment of the invention, coffee beans are freshly roasted, then freshly ground. The ground roasted coffee is then cold brewed by adding water at a temperature of less than 117° F. to the coffee grounds to produce a slurry. The slurry is then maintained for about 18 to 24 hours at 117° F. or below. The slurry is then filtered to yield a liquid coffee extract.

A drying process is applied to the liquid coffee extract obtained from the cold brew process described above. The extract is dried for a period sufficient to produce a powdered cold-brewed instant coffee.

The powdered cold-brewed instant coffee is vacuum packaged to result in a stable cold-brewed instant coffee product. This product has a shelf life of 2-3 years or more, when maintained at room temperature.

Because the brewing and drying processes are designed to minimize exposure of the product to temperatures above 117° F., there is minimal degradation of the coffee flavor in any coffee beverage prepared from the cold-brewed instant coffee.

In this manner, an instant coffee is produced that, upon the addition of water, yields a liquid coffee beverage that is full-flavored and low in acid. The instant coffee can be packaged, shipped, and delivered to a consumer for the preparation of a healthful, full-bodied, and low in acid liquid coffee beverage at a consumer's residence or a retail establishment.

The instant coffee is used to produce a liquid coffee beverage that is lower in tannin acid equivalents, overall acidic content, and diterpene levels. The instant coffee can be blended with other powders to which water can be added to produce a beverage, thereby allowing for the production of beverages having improved coffee characteristics, including flavors and aromas.

### Example 11

### General Method for Preparation of a Coffee Beverage Prepared From Cold-Brewed Instant Coffee

A coffee beverage is prepared by adding water to the cold-brewed instant coffee of Example 6 or Example 8. The instant coffee dissolves readily to produce the coffee beverage.

The beverage has a full bodied flavor with none of the bitter or off flavors of conventional instant coffee. The product has the coffee taste and aroma of fresh cold brewed coffee.

The beverage also has low acid and diterpene levels. The cold-brewed instant coffee produces a low acid coffee that is up to 70% lower in acidic compounds as compared to fresh-brewed coffee prepared via the drip percolation method. A low acid coffee is defined as a coffee that has less than half of the acidity of the same coffee prepared by a drip coffee process.

The cold-brewed instant coffee produces a low tannic acid coffee that is up to 60% lower in tannic acid equivalents than drip coffee. A low tannic acid coffee is defined as a coffee beverage that has less than half of the measurable tannic acid equivalents of a coffee beverage prepared using the same starting coffee but prepared by a drip coffee process.

The cold-brewed instant coffee also produces a low cafestol coffee, as measured in terms of mg % w/v of coffee beverage. The cold-brewed instant coffee also produces a low kahweol coffee, as measured in terms of mg % w/v of coffee beverage.

The coffee beverage prepared via the cold-brewed instant coffee therefore has all of the advantages of convenience of instant coffee and additionally has the health benefits of cold-brewed coffee, namely low diterpene levels and low acidity.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A method of producing an instant coffee, the method comprising:
adding water having a temperature of less than 117° F. to ground coffee beans to result in a slurry with liquid and solid components;
maintaining the slurry at a temperature below 117° F. for at least one hour;
separating the liquid component of the slurry from the solid component, to yield a liquid coffee extract; and
subjecting the liquid coffee extract to a drying process to remove water from the liquid coffee extract, to yield a solid coffee extract which can be used as an instant coffee.

2. The method of claim 1, wherein the coffee beans have been roasted.

3. The method of claim 1, wherein the slurry is prepared with water having a temperature of less than 90° F.

4. The method of claim 1, wherein separation of the liquid component of the slurry from the solid component comprises one or more of filtering, decanting, pressing, centrifuging, pressurizing and extracting with air, or pressurizing and extracting with steam.

5. The method of claim 1, wherein the drying process comprises one or more of freeze drying, spray drying, centrifugation, vacuum drying, use of radiant heat, drying at ambient temperature, application of infrared heat, evaporation, drum drying, dehydration, shelf drying, and solar drying.

6. The method of claim 1, wherein the drying process results in a coffee extract with a water content of less than 25%.

7. The method of claim 1, wherein the temperature during the drying process is at or below 160° F.

8. The method of claim 1, wherein the temperature during the drying process is at or below 117° F.

9. The method of claim 1, wherein the temperature during the drying process is above 117° F. for less than the entirety of the drying process.

10. An instant coffee prepared according to the method of claim 1.

11. The instant coffee of claim 10, further comprising one or more other instant coffee.

12. The instant coffee of claim 10, further comprising cacao or cocoa

13. The instant coffee of claim 12, further comprising one or more other instant coffee.

14. The instant coffee of claim 8, wherein the instant coffee is packaged under conditions that preserve the moisture content at less than about 5% by weight.

15. A coffee beverage prepared by adding water to the instant coffee of claim 10.
